(19) United States
(12) Patent Application Publication
(10) Pub. No.: US 2021/0272219 A1
(43) Pub. Date: Sep. 2, 2021

(54) METHOD OF COLLATING, ABSTRACTING, AND DELIVERING WORLDWIDE VIEWPOINTS

(71) Applicant: Abdulrhman Khald Mohammedkhalil, Jeddah (SA)

(72) Inventor: Abdulrhman Khald Mohammedkhalil, Jeddah (SA)

(21) Appl. No.: 17/327,082

(22) Filed: May 21, 2021

Related U.S. Application Data
(63) Continuation of application No. 16/443,750, filed on Jun. 17, 2019.
(60) Provisional application No. 62/721,155, filed on Aug. 22, 2018.

(51) Int. Cl. G06Q 50/00; G06F 17/18

(52) U.S. Cl. CPC G06Q 50/01; G06Q 50/26; G06F 17/18

(57) ABSTRACT

The present invention provides a system and method for presenting global issues to users and followers of a social media platform, allowing the users and followers to provide viewpoints on the global issues, and analyzing the various viewpoints to develop statistical data including the location of those providing viewpoints. The present invention also allows a user to present a global issue for consideration by users of the platform, for example, a social media internet-based website, and allows followers of the user to provide their viewpoints on such global issue. Simultaneously, the location of said followers will be collected and collated along with their responses.

### CROSS-REFERENCE TO RELATED APPLICATIONS

This application is a continuation of application Ser. No. 16/443,750, filed on Jun. 17, 2019, which claims priority to Provisional Application No. 62/721,155, filed on Aug. 22, 2018, the entire contents of which are hereby expressly incorporated by reference herein.

### BACKGROUND

As information relating to global political, social, and conflict issues continues to be more readily available to more people throughout the world, more people develop points of view about these matters. It can be useful for newspapers, political parties, business organizations, and other interested people to get statistical data from various people around the world on global matters.

Presently, social media systems are generally designed to be accessible internet based systems. Social media systems can take the form of blogs, microblogs, social networks, and the like. Various issues are presented and discussed over social media systems, however the issues may be answered anonymously, or by avatar-like identifiers. Further, it is not possible to determine the characteristics of people who are answering the issues. One particular characteristic that would be desirable would knowing the location of people answering the issue.

A system and method that has the capability to collect viewpoints relating to a global issue, and being able to also log data on the location of those who are providing the viewpoints is needed and desirable.

### BRIEF DESCRIPTION OF THE INVENTION

It is an object of the present invention to provide a system and method for presenting global issues to users and followers of a social media platform, allowing the users and followers to provide viewpoints on the global issue, and analyzing the various viewpoints to develop statistical data including the location of those providing viewpoints. It is a further object of the present invention to allow a user to present a global issue for consideration by users of platform, for example a social media internet-based website, and allow followers of the user to provide their viewpoints on such global issue. Simultaneously, the location of said followers will be collected and collated along with their responses.

### BRIEF DESCRIPTION OF THE DRAWINGS

FIG. 1 of the present invention exhibits the global issue being accessible by multi-users;

FIG. 2 of the present invention provides a method of operation;

FIG. 3 of the present invention exhibits the platform for use in the method of the present invention;

FIG. 4 exhibits the use of a device for accessing the platform of the present invention;

FIG. 5 exhibits the use of GPS satellite technology along with the platform of the present invention.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

As used herein, the term “prominent figure” refers to an individual, who either publicly or privately, has exercised or exhibited character traits that imbibe admirable characteristics, or who is memorable to someone personal.

As used herein, the term “interview” refers to presenting someone with a question, whereupon the person/interviewee answer the question, usually from their point of view. In reference to the present invention, the presentation of a question to an interviewee is performed by a virtual interviewer, such as questions presented on a computer.

With reference to the figures,

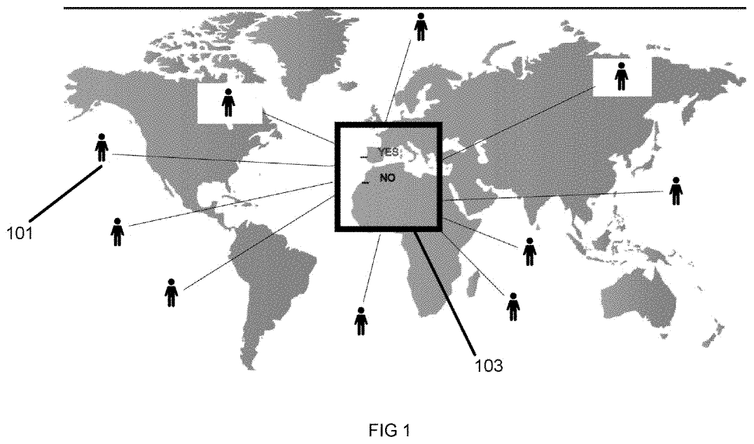

FIG. 1 provides an overall embodiment of the present invention, whereby worldwide viewpoints of a particular issues can be collected, collated, summarized, and distributed to multiples of users whom may be interested in the particular issues.

As shown in FIG. 1, the general elements involved in gathering worldwide viewpoints include the creation and distribution of a subject matter 103, to at least one user 101, whereby the user 101 can be located anywhere in the world.

The subject matter 103 preferably relates to an issue that is global in scope. Global in scope refers to an issue that may be related to or involve at least two different legal regimes. “Legal regimes” refers to a region of the world which has at least a legal government in power. Examples of legal regimes are countries, or administrative regions.

The subject matter 103 can be presented in a variety of different forms such as a questionnaire, survey, video, audio file, and the like. In one embodiment, the subject matter 103 presents an issue global in scope, then asks user 101 to provide their viewpoint by selecting one of several choices. In a preferred embodiment, users 101 select from 1 of 2 choices. However, the choices can be from 1 to 10 choices, or less.

Users 101 can be number from 1 to up to the population of the planet Earth. Users 101 are persons who have access to the subject matter 103 and desire to provide a viewpoint. Users may be located anywhere in the world. Users may gain access to the subject matter 103 through an internet-based platform when the subject matter was initially posted (direct access) or through a third-party internet-based platform (indirect access). Users can utilize a variety of devices to give direct or indirect access, including portable devices such as laptops, mobile phones, tabletop devices such as computers and the like.

As will be discussed later, user responses to the subject matter 103 will be collected, collated, analyzed, and distributed throughout the system and method.

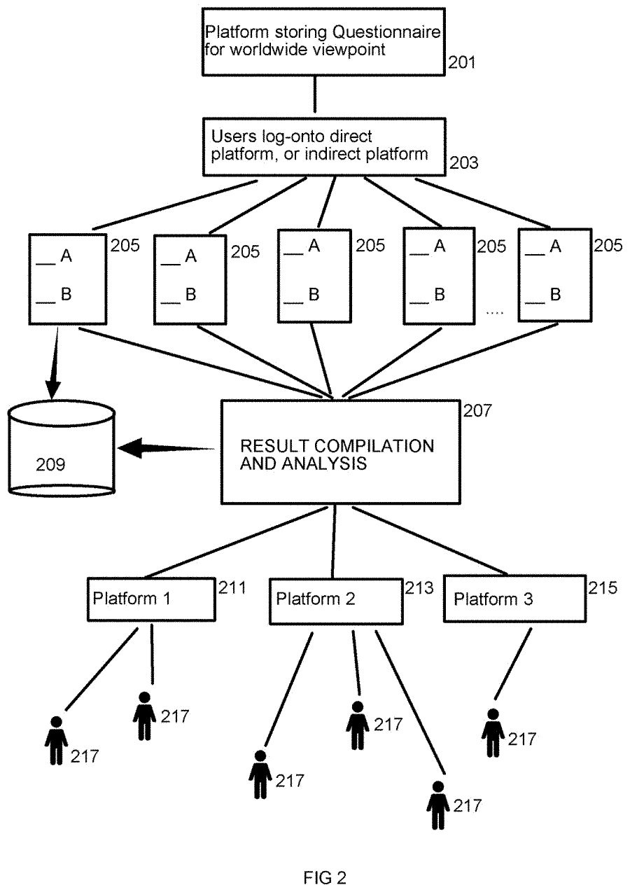

FIG. 2 is an embodiment of the method of the present invention, including presenting a subject matter and accepting responses from users.

As shown, subject matter requesting a worldwide viewpoint is set forth on a platform 201. Examples of such a platform include a website, or a digital social media platform. The platforms are present within the Internet. Users gain access to the subject matter 203 either directly, such as signing onto the platform upon which the subject matter was entered, or indirectly such as accessing a digital social media platform unto which the subject matter was “pushed” to.

To allow multiple users to access the subject matter, multiple instances of the subject matter are provided 205. Multiple instances will allow multiple responses to the subject matter, as well as provide data on the characteristics of the users who answer the subject matter.

Answer to the multiple instances of the subject matter are then complied and analyzed 207. Result compilation includes tallying the various responses in one answer or another. Additionally, details on the user data will be collated, including country of the users, age of the users, and the gender of the users. Users will either supply this information, or this information will be auto-collected, during answering the subject matter.

The results compilation and analysis as well as the subject will be stored in a storage 209. Simultaneously, the results compilation and analysis will be “pushed” to one of several platforms (211/213/215), including the platform upon which the subject matter was originally listed on, or on third-party platforms, such as social media platforms like Facebook, Instagram, LinkedIn, YouTube, WhatsApp, Google+, Facebook Messenger, WeChat, QQ, QZone, Tik Tok, Sina Weibo, Twitter, Reddit, Baidu Tieba, Skype, Viber, Snapchat, Line, Pinterest, Telegram, Tinder, Quora, Tumblr, Kakao talk, Kakao story, CYWORLD, MIXI, AMEBLO, MXit, BlackBerry Messenger, Vkontakte, XING, Viadeo, Odnoklassniki, and the like.

Various users will then be able to access the results 217 so they can then review a worldwide viewpoint relating to the issue.

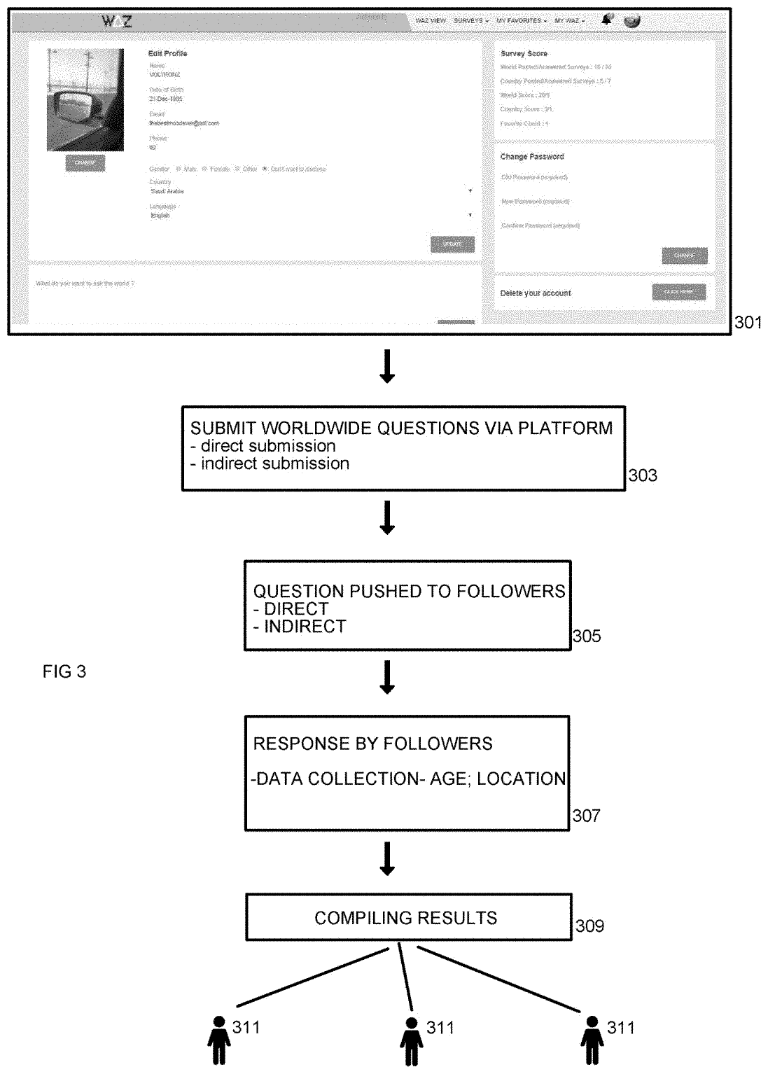

FIG. 3 is an embodiment of the present invention, wherein a means for entering a subject matter on a platform is shown.

At 301, a user may enter a subject matter using a platform, such subject matter will be delivered to users or followers of the subject-matter entering users. In entering a subject matter 302, the users may also enter profile data 304, such as which country the user is located in, the age of the user, preferred language of the user, user image, etc. The user may enter the subject matter and data in any language the user prefers. In a preferred embodiment, the method of the instant invention has auto-translation capability, which will allow users originally entered subject matter to be translated into different languages.

In an embodiment, the user enters in the subject matter directly unto the platform. In another embodiment, the user may enter in the subject matter using an unrelated third-party platform, for example a social media platform. The subject matter will be transmitted through the social media platform through to the direct platform 304.

The subject matter will then be “pushed” through to the users, or followers, of the subject-matter entering user. “Pushed” through to the users involves delivering to the user directly, through the platform 301, or indirectly, through third-party platforms, such as social media platforms.

Users, or followers, then provide responses to the subject matter 307. In addition, the followers can provide additional information such as location, age, etc. In one embodiment, data such as location is determined by global positioning satellite tracking incorporated within the platform of the present invention.

Results of user and follower answers are then compiled 309, generating statistical like information in terms of number of people when responding, number of people from a particular legal regime that responded, number of women that responded, etc. The compiled results 309 are then pushed to the users and followers 311 for their review.

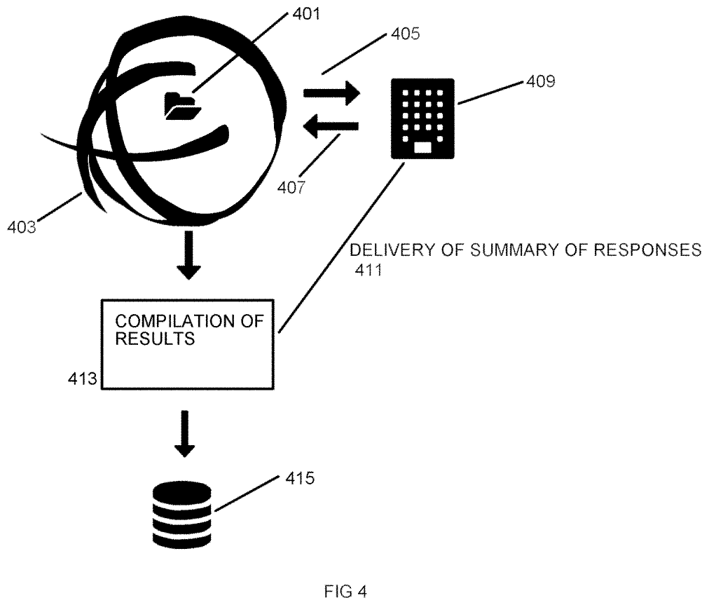

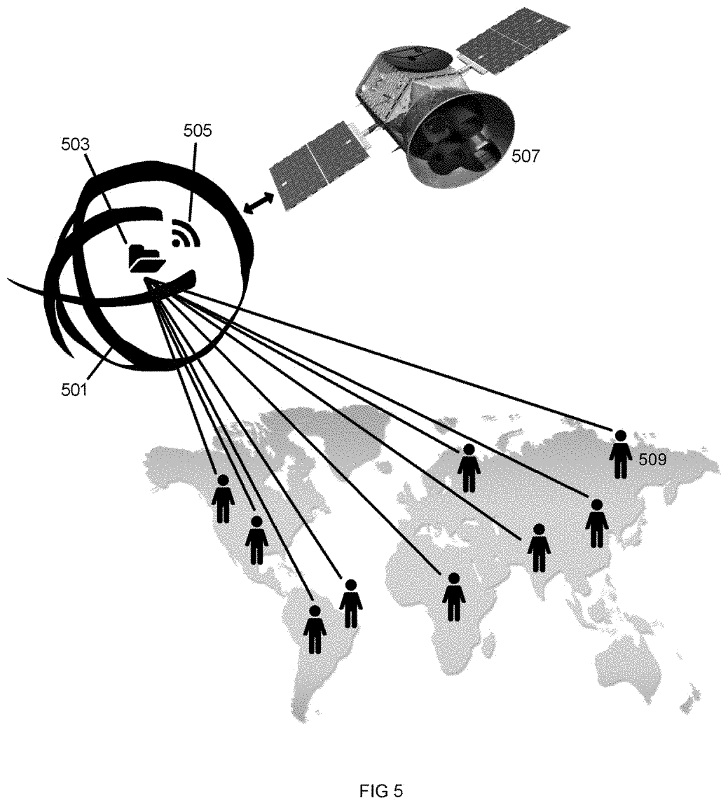

FIG. 4 is an embodiment of the devices used in the present invention, including a platform 401 allowing a user to enter in a new subject matter for worldwide dissemination to other users, whereby the platform 401 operates within a internet-based environment 403. As used herein, the Internet 403 is defined as a global hardware and software infrastructure that comprises public and private computer system that operate according to the Transmission Central Protocol (TCP) and Internet Protocol (IP) communication standards. The Internet is designed to receive, transmit, and route electronic information and data between computer systems and networks located around the world.

Via the Internet 403, the platform 401 is accessible and in communication for sending/pushing 405 and receiving 407 answers and subject matter to devices 409 controlled by users.

The results of answers 411 to subject matter are compiled 413 and stored 415, along with a copy of the subject matter.

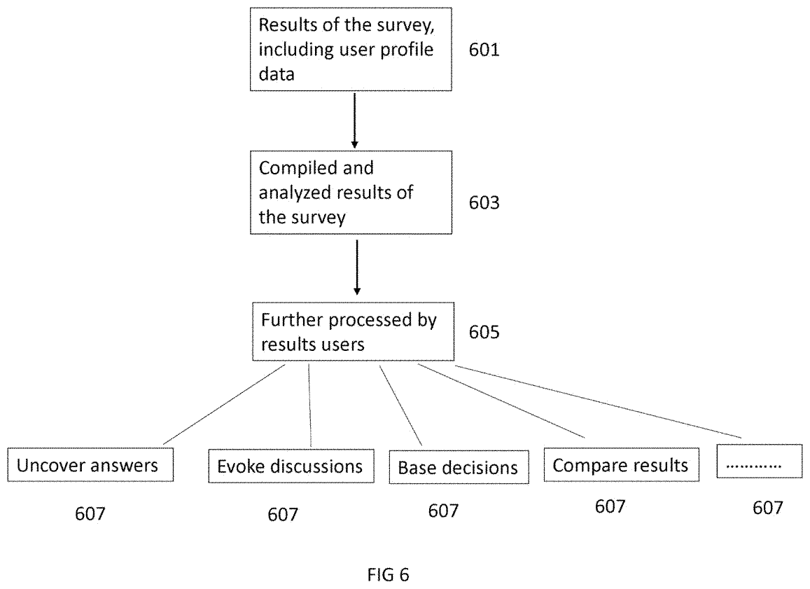

FIG. 5 is an embodiment of the inventive aspect of the present invention, which is the determination of location data of users and followers who answer pushed subject matter issues. Collection and collation of location data along with responses to subject matter issues gives reviews of the compiled results a worldwide viewpoint or feelings of perception regarding a global issue. As shown in FIG. 5, users 509 located throughout the world can have their location data recorded, for example by global positioning satellite (GPS) 507. In addition, location data can also be collected through WiFi, mobile transceivers, and identifying a current location of the mobile terminal, for example, in a restaurant, based on the collected location data.

The platform 503 of the invention, operating within the internet 501, will have communication means 505 in connection with GPS 507 technology.

What is claimed is:

1. A computer implemented method for collecting, collating, and distributing worldwide viewpoints of particular issues to multiple users who may be interested in said particular issues, the method comprising:
distributing from a internet-based platform a subject matter relating to said particular issues to user devices of said multiple users;
accessing said subject matter by said multiple users through the user devices;
providing viewpoints on said subject matter issues by one or more of said multiple users as well as user data through the user devices;
determining the location of the user devices of the multiple users who answered the distributed subject matter issues;
collecting and collating data of the location of the user devices of the multiple users who answered the distributed subject matter issues along with said viewpoints and said user data;
storing in a storage said subject matter as well as results of the collecting, collating and analyzing of said viewpoints and said user data;
pushing said results to other internet-based platforms; and
enabling viewers to review said results through said other internet-based platforms.

2. The method of claim 1, wherein said user data includes country, age, and gender of said multiple users.

3. The method of claim 1, wherein said multiple users are located anywhere in the world, wherein determining the location of the user devices of the multiple users who answer the pushed subject matter issues is done by a global positioning satellite.

4. The method of claim 1, wherein distributing said subject matter can be done in a variety of different forms including questionnaires, surveys, videos, audio files.

5. The method of claim 1, wherein providing viewpoints can be operated by selecting one of several choices.

6. The method of claim 1, wherein said internet-based platform unto where said subject matter is initially posted comprises a third-party internet-based platform.

7. The method of claim 1, wherein said internet-based platforms include websites and digital social media platforms.

8. The method of claim 1, wherein providing viewpoints by said multiple users can be operated in any language.

9. The method of claim 1, wherein the user devices comprise one of or any combination of a laptop, a mobile phone, and a computer table top device.

10. The method of claim 1, wherein said user data can further be auto-collected during answering said subject matter.

11. A computer implemented method for allowing a presenter to present a global issue for consideration by users of internet-based platforms, comprising:
entering a subject matter of said global issue by said presenter onto a presenter internet-based platform;
delivering said subject matter to said users of said internet-based platforms through user devices;
providing responses to said subject matter by said users of said internet-based platforms through said user devices; and
compiling results of said responses and generating statistical information; and
pushing said results and statistical information to said users and followers of said presenter.

12. The method of claim 12, wherein said presenter can further enter profile data comprising country, age, preferred language, and image of said presenter.

13. The method of claim 12, wherein said responses further comprise user data including country, age, and gender of said users.

14. The method of claim 12, wherein said internet-based platforms can be direct platforms and third-party platforms.

15. The method of claim 13, wherein said country data can be obtained by global positioning satellite tracking incorporated within said platforms and users offering while providing responses to said subject matter.

16. A system for collecting, collating, and distributing worldwide viewpoints of particular issues, comprises:
An internet-based platform, wherein said internet-based platform is configured to enable a presenter to enter a subject matter of said particular issues for worldwide dissemination, wherein said internet-based platform is further configured to enable platform users to send and receive answers from said platform users on said subject matter;
user devices controlled by platform users that can access said internet-based platform via an internet-based environment;
a remote processor for compiling and analyzing said answers; and
a remote storage device for storing said subject matter and said answers.

17. The system of claim 16, said platform further incorporates a global positioning satellite tracking system for determining the location of said platform users.

18. The system of claim 16, wherein said answers further include user data, said user data includes country, age, and gender of said users.

19. The system of claim 16, wherein said devices include portable devices, laptops, mobile phones, tabletops, computers.

20. The system of claim 16, wherein said platform has auto-translation capability, said capability allows an originally entered subject matter to be translated into different languages.
